(19) United States
(12) Patent Application Publication
(10) Pub. No.: US 2014/0198099 A1
(43) Pub. Date: Jul. 17, 2014

(54) DISPLAY-MODE SWITCHING DEVICE, STEREOSCOPIC DISPLAY DEVICE AND DISPLAY METHOD THEREOF

(71) Applicant: HANNSTAR DISPLAY CORP., New Taipei City (TW)

(72) Inventors: Heng-Cheng Tseng, Chiayi County (TW); Chih-Hsuan Lee, Tainan City (TW)

(73) Assignee: HannStar Display Corp., New Taipei City (TW)

(21) Appl. No.: 13/859,756

(22) Filed: Apr. 10, 2013

(30) Foreign Application Priority Data
Jan. 14, 2013 (CN) 201310012965.8

(51) Int. Cl. G02F 1/29

(52) U.S. Cl. CPC G02F 1/29
USPC 345/419; 359/315; 349/15

(57) ABSTRACT

A display-mode switching device includes a substrate, a plurality of first electrode stripes, a plurality of second electrode stripes, a plurality of third electrode stripes, a fourth electrode stripes, and a common electrode covering a surface of the substrate. The first electrode stripes, the second electrode stripes, the third electrode stripes and the fourth electrode stripes are disposed on the insulating layer, and each first electrode stripe, each third electrode stripe, each second electrode stripe and each fourth electrode stripe are sequentially arranged along a direction.

### BACKGROUND OF THE INVENTION

1. Field of the Invention

The present invention relates to a display-mode switching device, a stereoscopic display device and a display method thereof, and more particularly, to a display-mode switching device, a stereoscopic display device capable of switching two viewing angle display mode and four viewing angle display mode and a display method thereof.

2. Description of the Prior Art

The three-dimensional stereoscopic display technology could provide more alive stereoscopic images as compared with the two-dimensional planar display technology, and thus has become an important development tendency in the present display technology. Generally speaking, the principle of the stereoscopic display technology is to transmit a left eye image and a right eye image to the left eye and the right eye of the observer respectively, and since the difference of viewing angles of the left eye and the right eye, the images received by the left eye and the right eye can overlap each other and be analyzed by the cerebrum. Thus, the observer can see the depth and gradation of images and sense the stereoscopic image.

Conventional auto-stereoscopic display device usually is a parallax-barrier type stereoscopic display device, in which a parallax barrier is disposed in front of a display panel to shield the left eye and the right eye of the observer because the left eye and the right eye have different viewing angles. Thus, the observer can see the left eye image and the right eye image separately.

However, the parallax barrier of the conventional parallax-barrier type stereoscopic display device only can divide the image displayed with the display panel into two viewing angle images that are left eye image and right eye image, and the observer only can see stereoscopic image with two viewing angles accordingly. Furthermore, the parallax barrier is a fixed structure, and cannot be changed easily. Thus, the number of viewing angle images displayed by the conventional parallax-barrier type stereoscopic display device is limited.

### SUMMARY OF THE INVENTION

It is therefore an objective of the present invention to provide a stereoscopic display device and a display method thereof so as to increase the display modes of the stereoscopic display device and raise the number of the viewing angle frames displayed by the stereoscopic display device in different display modes.

According to an embodiment, the present invention provides a display-mode switching device including a first substrate having a first surface, a first electrode pattern, a second electrode pattern, a third electrode pattern, a fourth electrode pattern, and a common electrode. The first electrode pattern is disposed on the first substrate, and the first electrode pattern includes a plurality of first electrode stripes parallel to each other. The second electrode pattern is disposed on the first substrate, and the second electrode pattern includes a plurality of second electrode stripes parallel to each other. The third electrode pattern is disposed on the first substrate, and the third electrode pattern includes a plurality of third electrode stripes parallel to each other. The fourth electrode pattern is disposed on the first substrate, and the fourth electrode pattern includes a plurality of fourth electrode stripes parallel to each other, wherein each first electrode stripe, each third electrode stripe, each second electrode stripe and each fourth electrode stripe are sequentially arranged along a direction. The common electrode covers the first surface of the first substrate.

According to another embodiment, the present invention provides a stereoscopic display device including a display panel and a display-mode switching device. The display panel has a display surface, and the display-mode switching device disposed on the display surface.

According to another embodiment, the present invention provides a display method of a stereoscopic display device. First, the stereoscopic display device is provided to display a plurality of stereoscopic images in sequence, wherein each stereoscopic image includes a frame period, and each frame period includes a first sub-frame time, a second sub-frame time, a third sub-frame time, and a fourth sub-frame time. Next, a first sub-frame, a second sub-frame, a third sub-frame, and a fourth sub-frame are generated through the display panel based on each stereoscopic image. A first voltage signal, a second voltage signal, a third voltage signal, a fourth voltage signal, a reference voltage signal and a common voltage signal are provided to the first electrode pattern, the second electrode pattern, the third electrode pattern, the fourth electrode pattern, the reference electrode and the common electrode respectively.

According to another embodiment, the present invention provides a display method of a stereoscopic display device. First, the stereoscopic display device is provided to display a plurality of stereoscopic images in sequence, wherein each stereoscopic image includes a frame period, and each frame period includes a first sub-frame time and a second sub-frame time. Next, a first sub-frame and a second sub-frame are generated through the display panel based on each stereoscopic image. A first voltage signal, a second voltage signal, a third voltage signal, a fourth voltage signal, a reference voltage signal and a common voltage signal are provided to the first electrode pattern, the second electrode pattern, the third electrode pattern, the fourth electrode pattern, the reference electrode and the common electrode respectively.

The stereoscopic display device not only can display the stereoscopic image with four viewing angle frames, but also can display the stereoscopic image with two viewing angle frames through different display methods in the present invention. Accordingly, the number of the display modes of the stereoscopic display device can be increased, and the number of the viewing angle frames also can be increased in different modes. Thus, the observer can have more choices to choose the required display mode.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a cross-sectional view of a stereoscopic display device according to a first embodiment of the present invention.

FIG. 2 is a schematic diagram illustrating a top view of a display-mode switching device according to the first embodiment of the present invention.

FIG. 3 is a schematic diagram illustrating a cross-sectional view of a stereoscopic display device according to a second embodiment of the present invention.

FIG. 4 is a flow chart of a display method of a stereoscopic display device according to an embodiment of the present invention.

FIG. 5 is a schematic diagram illustrating timing sequences of the first voltage signal, the second voltage signal, the third voltage signal, the fourth voltage signal, the reference voltage signal, and the common voltage signal when the stereoscopic display device displays the stereoscopic images according to this embodiment of the present invention.

FIG. 6 through FIG. 9 are schematic diagrams illustrating four viewing angle frames divided by the display panel respectively according to this embodiment of the present invention.

FIG. 10 is a schematic diagram illustrating the stereoscopic display device displaying each stereoscopic image according to this embodiment of the present invention.

FIG. 11 is a schematic diagram illustrating the slits displayed by the display-mode switching device corresponding to four viewing angle frames according to this embodiment of the present invention.

FIG. 12 is a flow chart of a display method of the stereoscopic display device according to another embodiment of the present invention.

FIG. 13 is a schematic diagram illustrating timing sequences of the first voltage signal, the second voltage signal, the third voltage signal, the fourth voltage signal, the reference voltage signal, and the common voltage signal when the stereoscopic display device displays the stereoscopic images according to this embodiment of the present invention.

FIG. 14 through FIG. 15 are schematic diagrams illustrating two viewing angle frames divided by the display panel respectively according to this embodiment of the present invention.

FIG. 16 is a schematic diagram illustrating the first sub-frame and the second sub-frame according to this embodiment of the present invention.

FIG. 17 is a schematic diagram illustrating the slits displayed by the display-mode switching device corresponding to two viewing angle frames according to this embodiment of the present invention.

### DETAILED DESCRIPTION

To provide a better understanding of the present invention, exemplary embodiments will be detailed as follows. The exemplary embodiments of the present invention are illustrated in the accompanying drawings with numbered elements to elaborate the contents and effects to be achieved.

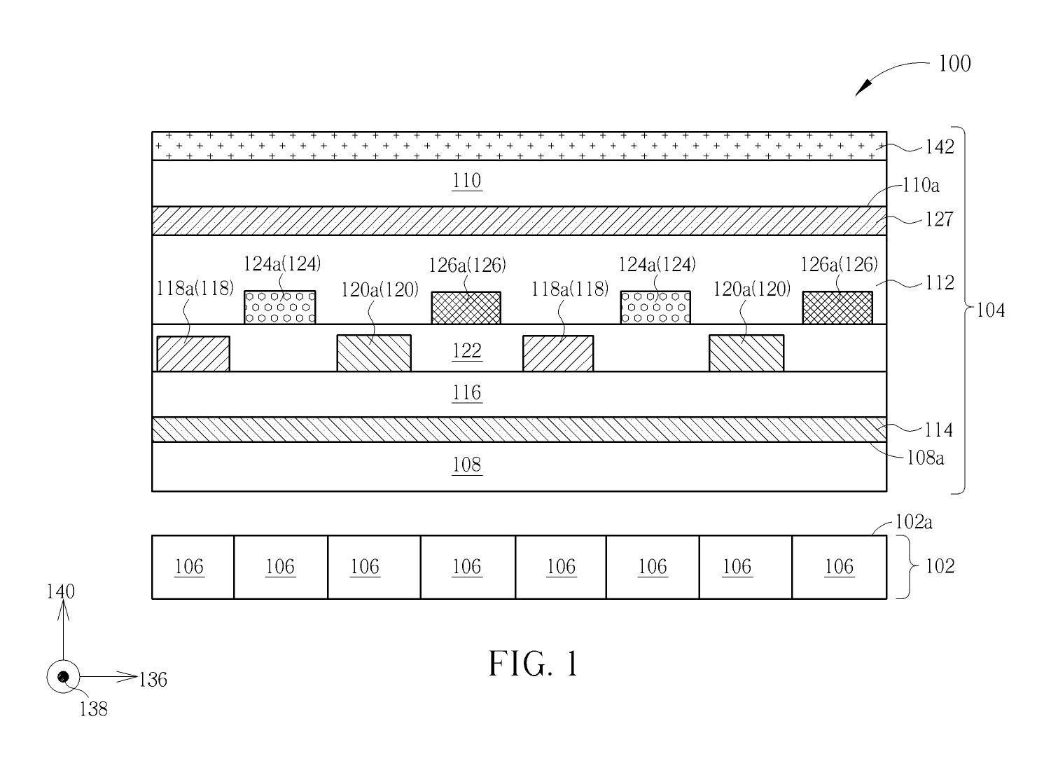

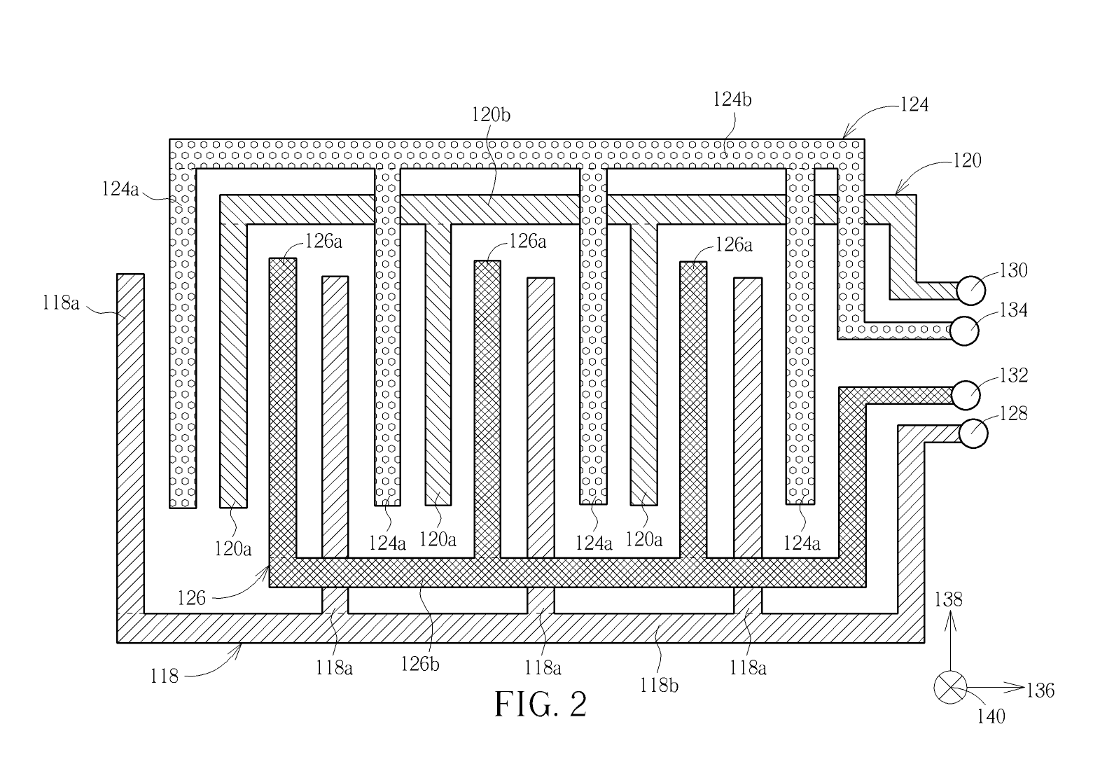

Please refer to FIG. 1 and FIG. 2. FIG. 1 is a schematic diagram illustrating a cross-sectional view of a stereoscopic display device according to a first embodiment of the present invention. FIG. 2 is a schematic diagram illustrating a top view of a display-mode switching device according to the first embodiment of the present invention. As shown in FIG. 1 and FIG. 2, the stereoscopic display device 100 includes a display panel 102 and a display-mode switching device 104 in this embodiment. The display panel 102 has a display surface 102a. The display-mode switching device 104 is disposed on the display surface 102a. The display panel 102 includes a plurality of pixel regions 106 arranged in an array formation, and is used to display a plurality of sub-frames. The display panel 102 may be a liquid crystal display panel, an organic light-emitting diode display panel, a plasma display panel, an electrophoresis display panel, a field emission display panel or other kinds of display panels. The display panel 102 can display different sub-frames based on different display modes of the stereoscopic display device 100.

In this embodiment, the display-mode switching device 104 includes a first substrate 108, a second substrate 110, a liquid crystal layer 112, a reference electrode 114, a first insulating layer 116, a first electrode pattern 118, a second electrode pattern 120, a second insulating layer 122, a third electrode pattern 124, a fourth electrode pattern 126, and a common electrode 127. The display-mode switching device 104 may serve as an active type parallax barrier and switch the display modes of the stereoscopic display device 100 based on the sub-frames displayed by the display panel 102. The first substrate 108 has a first surface 108a, and the second substrate 110 has a second surface 110a, in which the first surface 108a of the first substrate 108 is disposed opposite to the second surface 110a of the second substrate 110, and the first substrate 108 is disposed between the second substrate 110 and the display panel 102. The liquid crystal layer 112 is disposed between the first substrate 108 and the second substrate 110, and includes a plurality of liquid crystal molecules. The reference electrode 114 covers the first surface 108a of the first substrate 108. The first insulating layer 116 covers the reference electrode 114.

The first electrode pattern 118 and the second electrode pattern 120 are disposed on the first insulating layer 116, and are not in contact with each other. In this embodiment, the first electrode pattern 118 and the second electrode pattern 120 may be formed with a same electrode layer, but the present invention is not limited thereto. The first electrode pattern 118 includes a plurality of first electrode stripes 118a and a first conductive line 118b. The first electrode stripes 118a are parallel to each other. The first conductive line 118b is connected to the first electrode stripes 118a, and the first electrode stripes 118a are electrically connected to a first signal end 128 through the first conductive line 118b.

The second electrode pattern 120 includes a plurality of second electrode stripes 120a and a second conductive line 120b, in which the second electrode stripes 120a are parallel to each other. The second conductive line 120b is connected to the second electrode stripes 120a, and the second electrode stripes 120a are electrically connected to a second signal end 130 through the second conductive line 120b. The second insulating layer covers the first insulating layer 116, the first electrode pattern 118, and the second electrode pattern 120.

The third electrode pattern 124 and the fourth electrode pattern 126 are disposed on the second insulating layer 122, and are not in contact with each other. In this embodiment, the third electrode pattern 124 and the fourth electrode pattern 126 may be formed with a same electrode layer, but the present invention is not limited thereto. The third electrode pattern 124 includes a plurality of third electrode stripes 124a and a third conductive line 124b. The third electrode stripes 124a are parallel to each other. The third conductive line 124b is connected to the third electrode stripes 124a, and the third electrode stripes 124a are electrically connected to a third signal end 132 through the third conductive line 124b

The fourth electrode pattern 126 includes a plurality of fourth electrode stripes 126a and a fourth conductive line 126b, in which the fourth electrode stripes 126a are parallel to each other. The fourth conductive line 126b is connected to the fourth electrode stripes 126a, and the fourth electrode stripes 126a are electrically connected to a fourth signal end 134 through the fourth conductive line 126b. Each first electrode stripe 118a, each second electrode stripe 120a, each third electrode stripe 124a and each fourth electrode stripe 126a are parallel to one another, and each first electrode stripe 118a, each third electrode stripe 124a, each second electrode stripe 120a and each fourth electrode stripe 126a are sequentially arranged along a first direction 136, in which the first direction 136 is parallel to a row direction of the array of the pixel regions 106 of the display panel 102. It is to say that each first electrode stripe 118a, each second electrode stripe 120a, each third electrode stripe 124a and each fourth electrode stripe 126a extend along a second direction 138 that is column direction of the array of the pixel region 106 of the display panel 102 and is perpendicular to the first direction 136 respectively. The common electrode 127 covers the second surface 110a of the second substrate 110.

It should be noted that each first electrode stripe 118a, each second electrode stripe 120a, each third electrode stripe 124a and each fourth electrode stripe 126a do not overlap one another in a third direction 140 perpendicular to the display surface 102a, so that arrangement directions of the liquid crystal molecules in different portions of the liquid crystal layer 112 respectively corresponding to each first electrode stripe 118a, each second electrode stripe 120a, each third electrode stripe 124a and each fourth electrode stripe 126a can be controlled by adjusting the voltage in each first electrode stripe 118a, adjusting the voltage in each second electrode stripe 120a, adjusting the voltage in each third electrode stripe 124a and adjusting the voltage in each fourth electrode stripe 126a respectively. Accordingly, the display-mode switching device 104 can display a plurality of slits sequentially arranged along the first direction 136, and the positions of the slits can be adjusted in different times. For this reason, the different sub-frames displayed by the display panel 102 can pass through the slits, and then different viewing angle images can be displayed in different viewing angles regions, thereby displaying a stereoscopic image. Furthermore, a voltage difference is provided between the reference electrode 114 and the common electrode 127, and the position of the display-mode switching device 104 outside the slits can display black. Additionally, the display-mode switching device 104 may further include a polarizer 142 disposed on the outside of the second substrate 110, in which the polarization direction of the polarizer 142 and the polarization direction of light generated from the display panel 102 are perpendicular to each other, and the display-mode switching device 104 in this embodiment may be of the normally white type. The present invention is not limited thereto. In a modified embodiment of the present invention, the display-mode switching device may be of the normally black type, and the polarization of the polarizer may be parallel to the polarization of the light generated from the display panel. The second substrate also may be disposed between the first substrate and the display panel.

The stereoscopic display device in the present invention is not limited to the above-mentioned embodiment. The following description continues to detail the other embodiments or modifications, and in order to simplify and show the differences between the other embodiments or modifications and the above-mentioned embodiment, the same numerals denote the same components in the following description, and the same parts are not detailed redundantly.

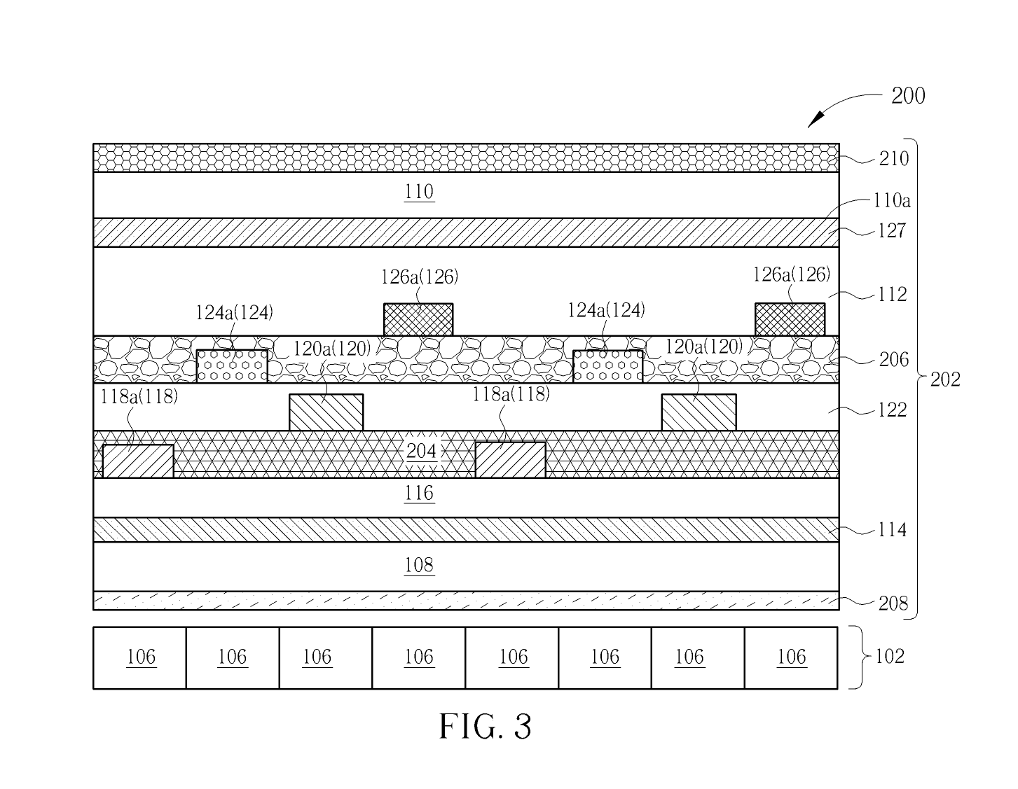

Please refer to FIG. 3. FIG. 3 is a schematic diagram illustrating a cross-sectional view of a stereoscopic display device according to a second embodiment of the present invention. As shown in FIG. 3, as compared with the first embodiment, the display-mode switching device 202 of the stereoscopic display device 200 in this embodiment further includes a third insulating layer 204 and a fourth insulating layer 206. Furthermore, in this embodiment, the third insulating layer 204 covers the first electrode pattern 118, and the second electrode pattern 120 is disposed on the third insulating layer 204, so that the third insulating layer 204 is disposed between the first electrode pattern 118 and the second electrode pattern 120 and is used to electrically insulate the first electrode pattern 118 from the second electrode pattern 120. The fourth insulating layer 206 covers the third electrode pattern 124, and the fourth electrode pattern 126 is disposed on the fourth insulating layer 206, so that the fourth insulating layer 206 is disposed between the third electrode pattern 124 and the fourth electrode pattern 126 and is used to electrically insulate the third electrode pattern 124 from the fourth electrode pattern 126. Specifically, the first electrode pattern 118, the second electrode pattern 120, the third electrode pattern 124, and the fourth electrode pattern 126 are formed with different electrode layers, and any two of the electrode patterns adjacent to each other are insulated from each other through an insulating layer. In a modified embodiment of the present invention, the display-mode switching device may only include the first, second and third insulating layers, in which the third insulating layer is disposed between the first electrode pattern and the second electrode pattern, and the third electrode pattern and the fourth electrode pattern are formed with the same electrode layer. Or, the display-mode switching device may also only include the first, second and fourth insulating layers. The first electrode pattern and the second electrode pattern are formed with the same electrode layer, and the fourth insulating layer is disposed between the third electrode pattern and the fourth electrode pattern. Additionally, the display-mode switching device 202 in this embodiment may further include a first polarizer 208 and a second polarizer 210 disposed on the outside of the first substrate 108 and the outside of the second substrate 110 respectively, in which the polarization direction of the first polarizer 208 and the polarization direction of the second polarizer 210 are perpendicular to each other. Furthermore, the light generated from the display panel in this embodiment may not have a specific polarization direction, but the present invention is not limited thereto. The polarization direction of the light generated from the display panel may be the same as the polarization direction of the first polarizer in the present invention.

Moreover, a sequence of the first electrode pattern, the second electrode pattern, the third electrode pattern, and the fourth electrode pattern stacked on the first insulating layer in the present invention is not limited to the above embodiment. In a modified embodiment of the present invention, the first electrode pattern and the second electrode pattern may be disposed on the third electrode pattern and the fourth electrode pattern. Or, the first electrode pattern, the second electrode pattern, the third electrode pattern and the fourth electrode pattern may be sequentially disposed on the first insulating layer or be disposed on the first insulating layer according to any sequence of the first, second, third and fourth electrode patterns. Or, the first, second, third and fourth electrode patterns are directly disposed on the first insulating layer.

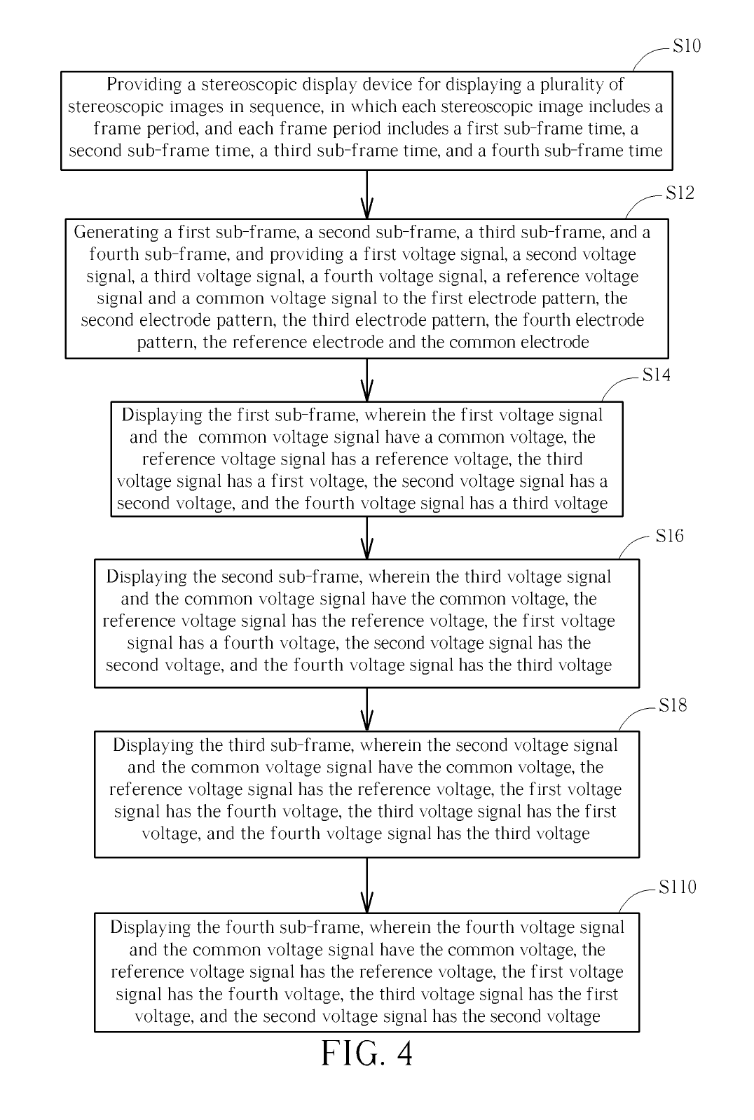

The display method of the stereoscopic display for displaying a stereoscopic image with four viewing angles will be further detailed in the following description. Please refer to FIG. 4 together with FIG. 1. FIG. 4 is a flow chart of a display method of a stereoscopic display device according to an embodiment of the present invention. As shown in FIG. 1 and FIG. 4, the stereoscopic display device 100 operates in a display mode for displaying four viewing angle frames in this embodiment. The display method of the stereoscopic display device 100 includes the following steps:

Step S10: providing a stereoscopic display device 100 for displaying a plurality of stereoscopic images in sequence, in which each stereoscopic image includes a frame period, and each frame period includes a first sub-frame time, a second sub-frame time, a third sub-frame time, and a fourth sub-frame time;

Step S12: generating a first sub-frame, a second sub-frame, a third sub-frame, and a fourth sub-frame through the display panel 102 based on each of the stereoscopic images, and providing a first voltage signal, a second voltage signal, a third voltage signal, a fourth voltage signal, a reference voltage signal and a common voltage signal to the first electrode pattern 118, the second electrode pattern 120, the third electrode pattern 124, the fourth electrode pattern 126, the reference electrode 114 and the common electrode 127;

Step S14: displaying the first sub-frame in each first sub-frame time, wherein the first voltage signal and the common voltage signal have a common voltage, the reference voltage signal has a reference voltage, the third voltage signal has a first voltage, the second voltage signal has a second voltage, and the fourth voltage signal has a third voltage in each first sub-frame time;

Step S16: displaying the second sub-frame in each second sub-frame time, wherein the third voltage signal and the common voltage signal have the common voltage, the reference voltage signal has the reference voltage, the first voltage signal has a fourth voltage, the second voltage signal has the second voltage, and the fourth voltage signal has the third voltage in each second sub-frame time;

Step S18: displaying the third sub-frame in each third sub-frame time, wherein the second voltage signal and the common voltage signal have the common voltage, the reference voltage signal has the reference voltage, the first voltage signal has the fourth voltage, the third voltage signal has the first voltage, and the fourth voltage signal has the third voltage in each third sub-frame time; and

Step S110: displaying the fourth sub-frame in each fourth sub-frame time, wherein the fourth voltage signal and the common voltage signal have the common voltage, the reference voltage signal has the reference voltage, the first voltage signal has the fourth voltage, the third voltage signal has the first voltage, and the second voltage signal has the second voltage in each fourth sub-frame time.

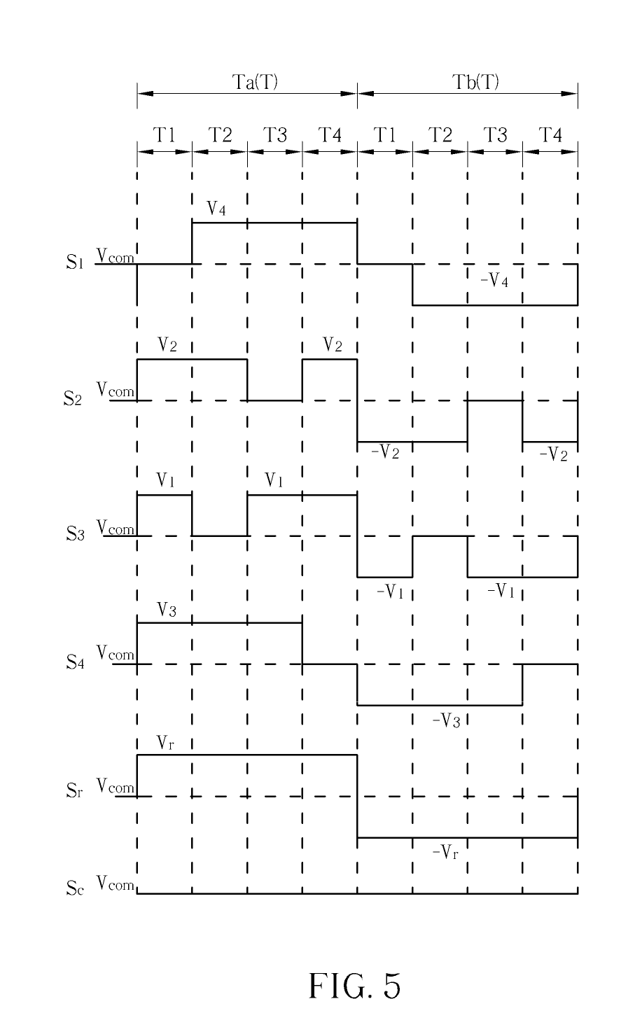

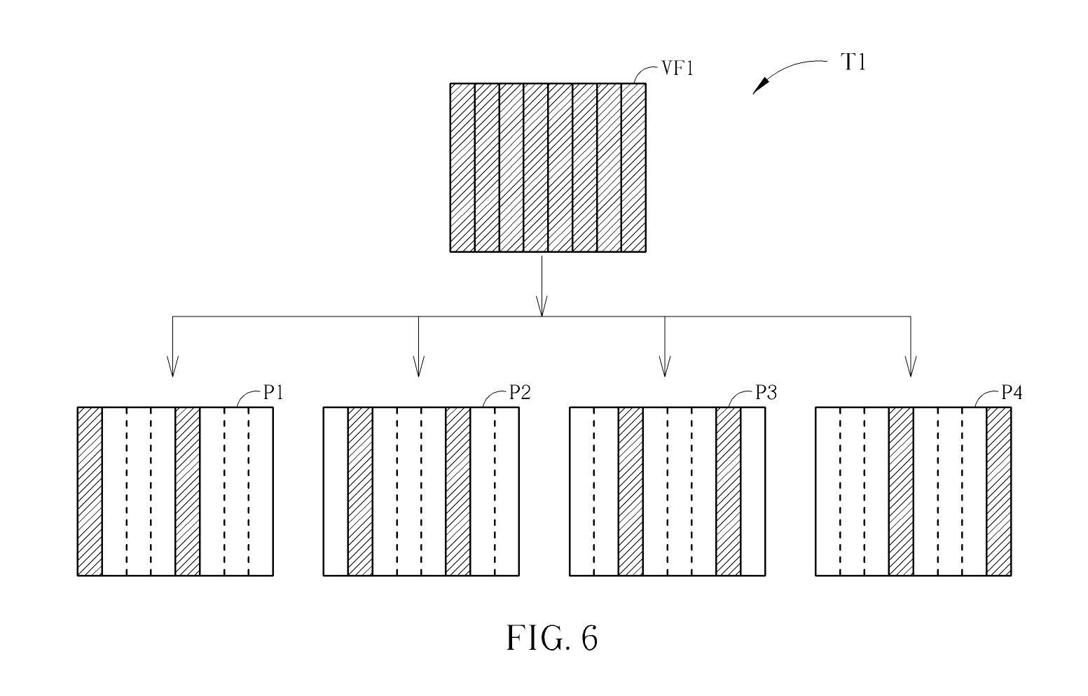

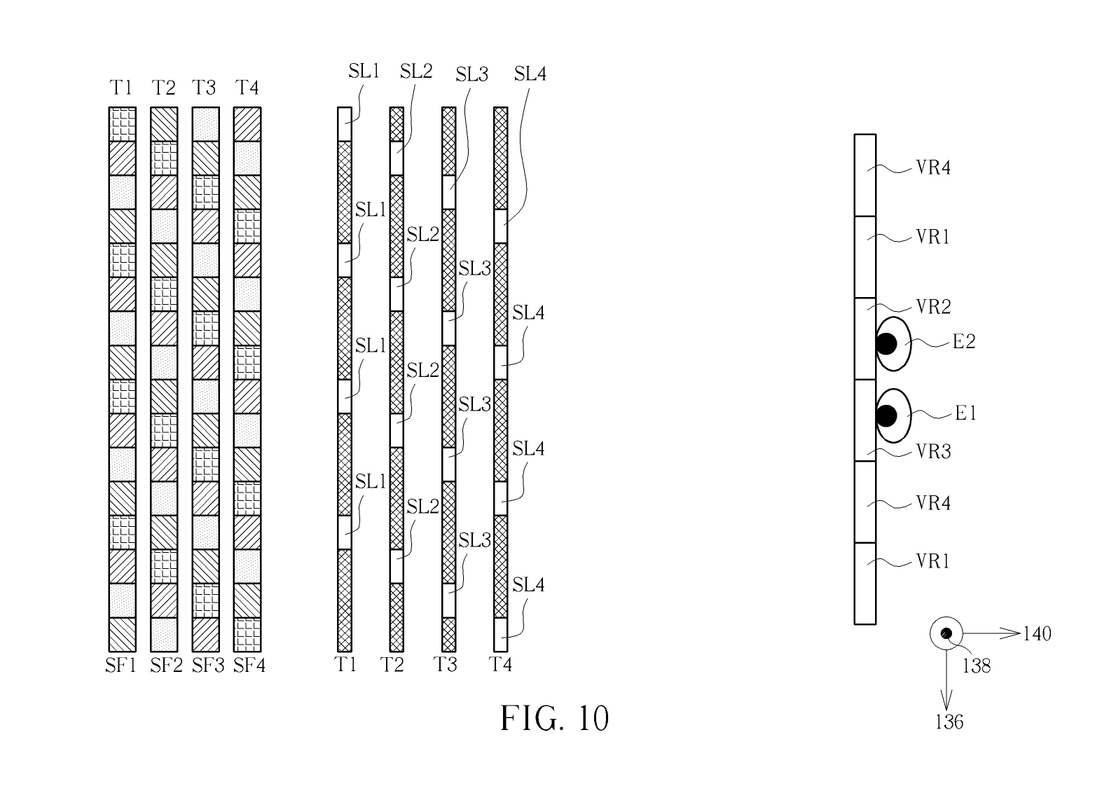

Please refer to FIG. 5 through FIG. 10 together with FIG. 1 and FIG. 4. FIG. 5 is a schematic diagram illustrating timing sequences of the first voltage signal, the second voltage signal, the third voltage signal, the fourth voltage signal, the reference voltage signal, and the common voltage signal when the stereoscopic display device displays the stereoscopic images according to this embodiment of the present invention. FIG. 6 through FIG. 9 are schematic diagrams illustrating four viewing angle frames divided by the display panel respectively according to this embodiment of the present invention. FIG. 10 is a schematic diagram illustrating the stereoscopic display device displaying each stereoscopic image according to this embodiment of the present invention. As shown in FIG. 1, FIG. 4, FIG. 5 and FIG. 10, the display method of this embodiment takes the stereoscopic display device 100 of the first embodiment as an example, but the present invention is not limited thereto. Each stereoscopic image includes the frame period T, and the frame period T includes a first sub-frame time T1, a second sub-frame time T2, a third sub-frame time T3 and a fourth sub-frame time T4 in sequence. For the sake of clarity, the following description takes single one stereoscopic image as an example to detail the display method of the stereoscopic display device 100 for displaying each stereoscopic image. The present invention is not limited herein. The stereoscopic image is formed with four viewing angle frames, and the four viewing angle frames can be divided into a first viewing angle frame VF1, a second viewing angle frame VF2, a third viewing angle frame VF3, a fourth viewing angle frame VF4 in this embodiment. The first viewing angle frame VF1 is displayed in a plurality of first viewing angle regions VR1; the second viewing angle frame VF2 is displayed in a plurality of second viewing angle regions VR2; the third viewing angle frame VF3 is displayed in a plurality of third viewing angle regions VR3; and the fourth viewing angle frame VF4 is displayed in a plurality of fourth viewing angle regions VR4. Each first viewing angle region VR1, each second viewing angle region VR2, each third viewing angle region VR3 and each fourth viewing angle region VR4 are sequentially arranged along the first direction 136. Also, there is a specific distance between the stereoscopic display device 100 and the first, second, third and fourth viewing angle regions VR1, VR2, VR3,VR4. Thus, a left eye E1 and a right eye E2 of an observer can be respectively located at two of each first viewing angle region VR1, each second viewing angle region VR2, each third viewing angle region VR3 and each fourth viewing angle region VR4 adjacent to each other to see the stereoscopic image.

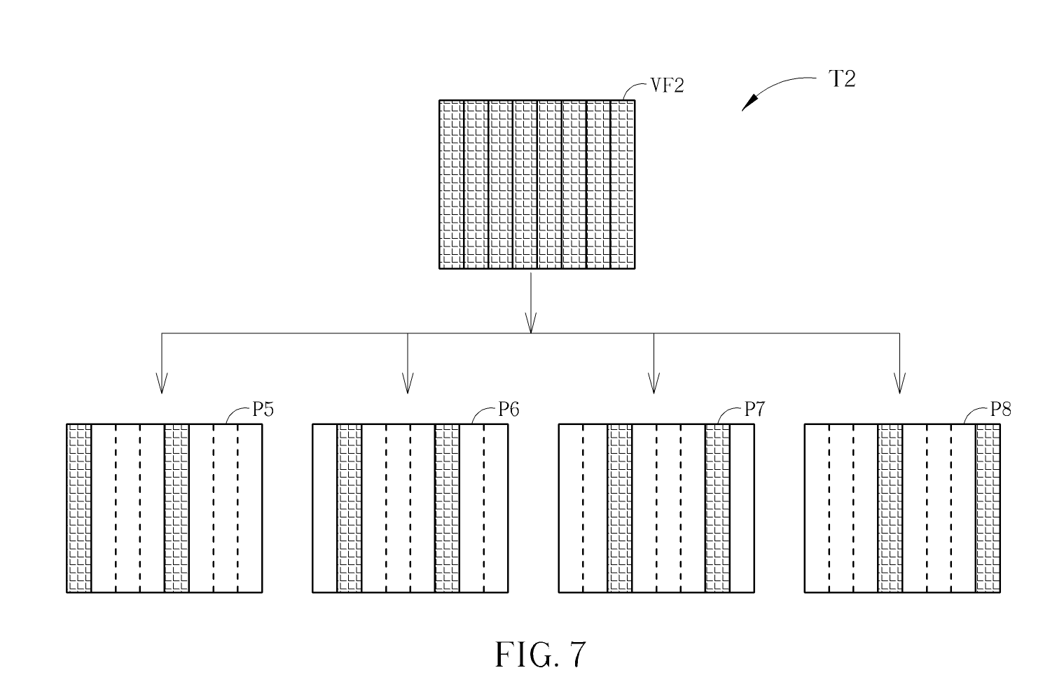

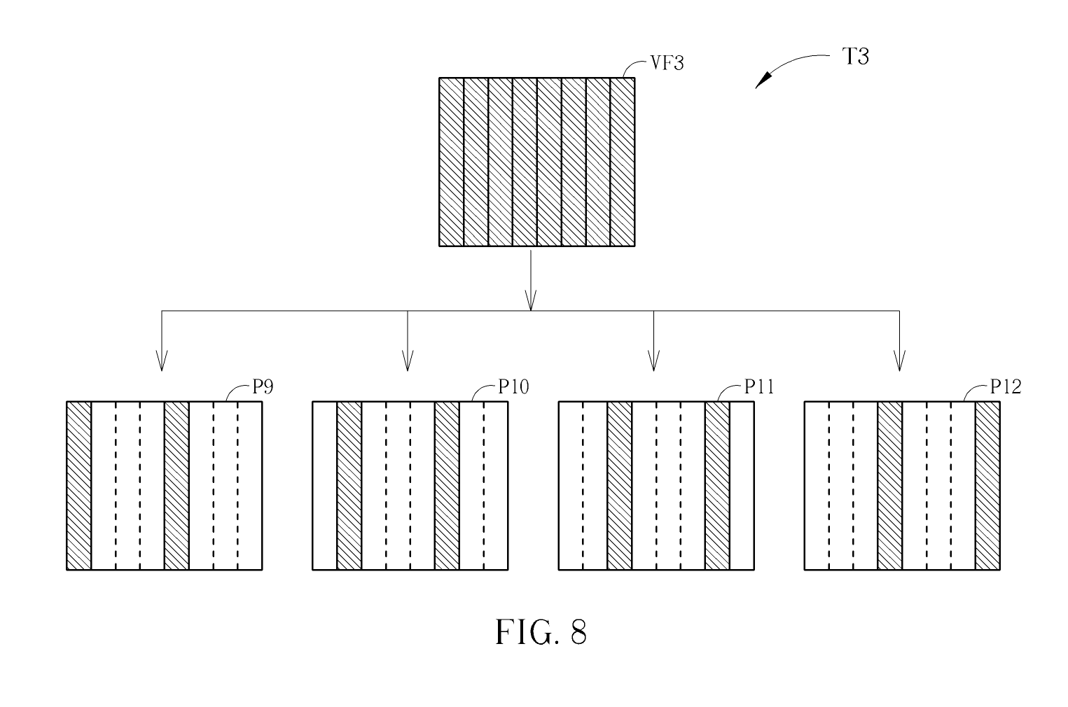

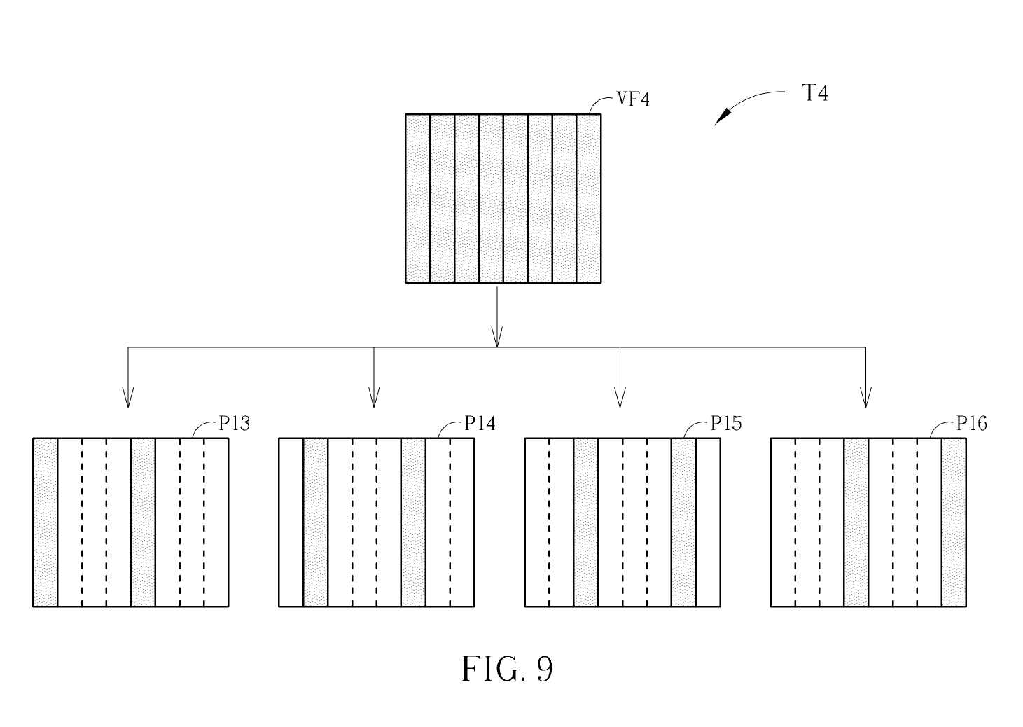

In step S12, the display panel 102 generates a first sub-frame SF1, a second sub-frame SF2, a third sub-frame SF3 and a fourth sub-frame SF4 based on the stereoscopic image and displays the first sub-frame SF1, the second sub-frame SF2, the third sub-frame SF3 and the fourth sub-frame SF4 in sequence. Also, the first sub-frame SF1, the second sub-frame SF2, the third sub-frame SF3 and the fourth sub-frame SF4 can be displayed in different viewing angle regions through the switch of the display-mode switching device 104 so as to display different viewing angle frames, and the stereoscopic display device 100 can display the stereoscopic image accordingly. The method of the display panel 102 for generating the first sub-frame SF1, the second sub-frame SF2, the third sub-frame SF3 and the fourth sub-frame SF4 is detailed in the following description, but is not limited herein. In this embodiment, the display panel 102 first divides the first viewing angle frame VF1 into a first part P1, a second part P2, a third part P3 and a fourth part P4, as shown in FIG. 6. Similarly, as shown in FIG. 7, the display panel 102 divides the second viewing angle frame VF2 into a fifth part P5, a sixth part P6, a seventh part P7 and an eighth part P8. Also, as shown in FIG. 8, the display panel 102 divides the third viewing angle frame VF3 into a ninth part P9, a tenth part P10, an eleventh part P11 and a twelfth part P12. As shown in FIG. 9, the display panel 102 divides the fourth viewing angle frame VF4 into a thirteenth part P13, a fourteenth part P14, a fifteenth part P15 and a sixteenth part P16. As shown in FIG. 10, after the display panel 102 divides the viewing angle frames, the display panel 102 merges the fifth part P5, the second part P2, the fifteenth part P15 and the twelfth part P12 into the first sub-frame SF1, merges the ninth part P9, the sixth part P6, the third part P3 and the sixteenth part P16 into the second sub-frame SF2, merges the thirteenth part P13, the tenth part P10, the seventh part P7 and the fourth part P4 into the third sub-frame SF3, and merges the first part P1, the fourteenth part P14, the eleventh part P11 and the eighth part P8 into the fourth sub-frame SF4. The first sub-frame SF1, the second sub-frame SF2, the third sub-frame SF3 and the fourth sub-frame SF4 in the present invention are not limited to the above-mentioned description, and may be adjusted and matched based on the positions of the slits displayed by the display-mode switching device. In a modified embodiment of the present invention, the first sub-frame, the second sub-frame, the third sub-frame and the fourth sub-frame may be formed with different parts. For example, the first sub-frame may be formed with the first part, the sixth part, the eleventh part and the sixteenth part; the second sub-frame may be formed with the second part, the seventh part, the twelfth part, the thirteenth part; the third sub-frame may be formed with the third part, the eighth part, the ninth part and the fourteenth part; and the fourth sub-frame may be formed with the fourth part, the fifth part, the tenth part and the fifteenth part, but the present invention is not limited herein.

In the display-mode switching device 104, the first voltage signal S1 may be transmitted to the first electrode stripes 118a through the first signal end 128 and the first conductive line 118b. The second voltage signal S2 may be transmitted to the second electrode stripes 120a through the second signal end 130 and the second conductive line 120b. The third voltage signal S3 may be transmitted to the third electrode stripes 124a through the third signal end 132 and the third conductive line 124b. The fourth voltage signal S4 may be transmitted to the fourth electrode stripes 126a through the fourth signal end 134 and the fourth conductive line 126b. Furthermore, the first voltage signal S1, the second voltage signal S2, the third voltage signal S3, the fourth voltage signal S4, the reference voltage signal Sr and the common voltage signal Sc may be provided with a control device, but the present invention is not limited thereto.

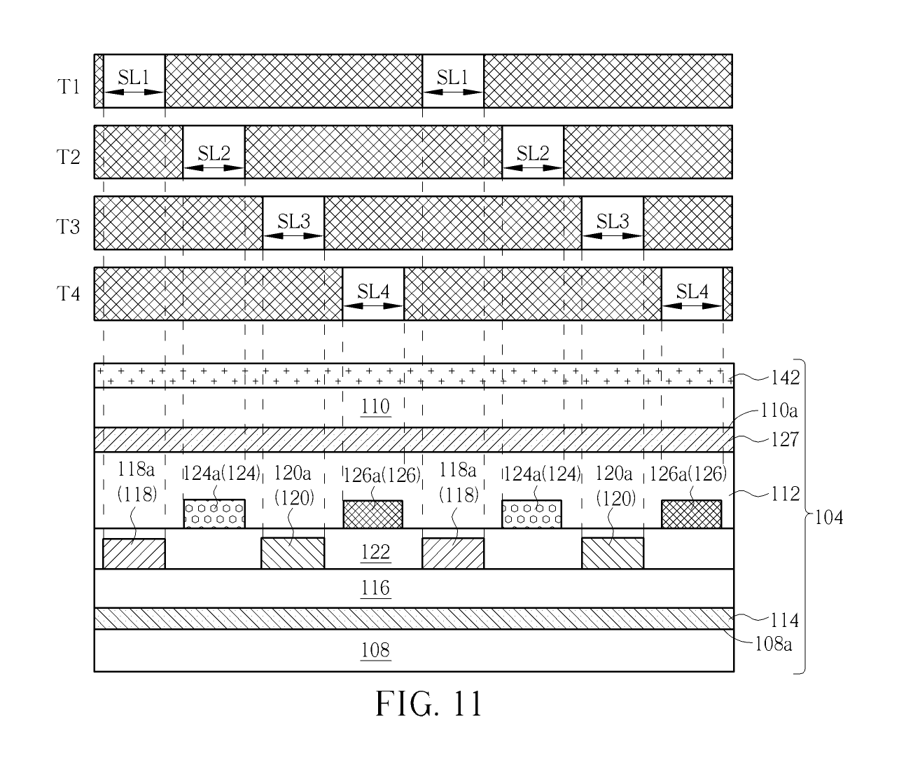

Please refer to FIG. 11 together with FIG. 1, FIG. 4, FIG. 5 and FIG. 10. FIG. 11 is a schematic diagram illustrating the slits displayed by the display-mode switching device corresponding to four viewing angle frames according to this embodiment of the present invention. As shown in FIG. 1, FIG. 4, FIG. 10 and FIG. 11, in step S14, the display panel 102 displays the first sub-frame SF1 in the first sub-frame time T1. Also, in the first sub-frame time T1, the first voltage signal S1 and the common voltage signal Sc have the common voltage Vcom, such as 0 volts, but are not limited thereto. The reference voltage signal Sr has the reference voltage Vr larger than the common voltage Vcom in the first sub-frame time T1. For example, a voltage difference between reference voltage Vr and the common voltage may be ranged from 2 volts to 6 volts, but is not limited thereto. The third voltage signal S3 has the first voltage V1 larger than the common voltage Vcom in the first sub-frame time T1. For example, a voltage difference between the first voltage V1 and the common voltage Vcom may be ranged from 2 volts to 6 volts, but is not limited thereto. The second voltage signal S2 has the second voltage V2 larger than the common voltage in the first sub-frame time T1. For example, a voltage difference between the second voltage V2 and the common voltage Vcom may be ranged from 2 volts to 6 volts, but is not limited thereto. The fourth voltage signal S4 has the third voltage V3 larger than the common voltage Vcom in the first sub-frame time T1. For example, a voltage difference between the third voltage V3 and the common voltage Vcom may be ranged from 2 volts to 6 volts, but is not limited thereto. It should be noted that the voltage difference between the reference voltage Vr and the common voltage Vcom is ranged from 2 volts to 6 volts; the voltage difference between the first voltage V1 and the common voltage Vcom is ranged from 2 volts to 6 volts; the voltage difference between the second voltage V2 and the common voltage Vcom is ranged from 2 volts to 6 volts; and the voltage difference between the third voltage V3 and the common voltage Vcom is ranged from 2 volts to 6 volts in this embodiment. By doing that, regions of the display-mode switching device 104 without overlapping the first electrode stripes 118a will display black, and the first sub-frame SF1 displayed by the display panel 102 cannot pass through the regions of the display-mode switching device 104 without overlapping the first electrode stripes 118a. Also, the first electrode stripes 118a and the common electrode 127 have the same common electrode Vcom, so that there is no voltage difference between the first electrode stripes 118a and the common electrode 127. Accordingly, regions of the display-mode switching device 104 overlapping the first electrode stripes 118a can be transparent, which acts in a “pass through” mode, and a plurality of first slits SL1 respectively corresponding to the first electrode stripes 118a can be displayed. Thus, the fifth part P5 of the first sub-frame SF1 displayed by the display panel 102 can pass through the first slits SL1 and display in the second viewing angle regions VR2; the second part P2 of the first sub-frame SF1 can pass through the first slits SL1 and display in the first viewing angle regions VR1; the fifteenth part P15 can pass through the first slits SL1 and display in the fourth viewing angle regions VR4; and the twelfth part P12 can pass through the first slits SL1 and display in the third viewing angle regions VR3. In this embodiment, the reference voltage Vcom is the same as the first voltage V1, the second voltage V2 and the third voltage V3, but the present invention is not limited thereto. Furthermore, the second electrode pattern 120, the third electrode pattern 124 and the fourth electrode pattern 126 can be electrically connected to one another in the first sub-frame time T1, so that the first voltage V1, the second voltage V2 and the third voltage V3 can be the same.

In step S16, the display panel 102 displays the second sub-frame SF2 in the second sub-frame time T2. In the second sub-frame time T2, the third voltage signal S3 and the common voltage signal Sc have the common voltage Vcom; the reference voltage signal Sr still has the reference voltage Vr larger than the common voltage Vcom; the first voltage signal S1 has the fourth voltage V4 larger than the common voltage Vcom, for example, a voltage difference between the fourth voltage V4 and the common voltage Vcom being ranged from 2 volts to 6 volts, but is not limited thereto; the second voltage signal S2 still has the second voltage V2; and the fourth voltage signal S4 still has the third voltage V3. It should be noted that the voltage difference between the fourth voltage V4 and the common voltage Vcom is ranged from 2 volts to 6 volts. Accordingly, regions of the display-mode switching device 104 without overlapping the third electrode stripes 124a will display black, and the second sub-frame SF2 displayed by the display panel 102 cannot pass through the regions of the display-mode switching device 104 without overlapping the third electrode stripes 124a. Also, the third electrode stripes 124a and the common electrode 127 have the same common electrode Vcom, so that there is no voltage difference between the third electrode stripes 124a and the common electrode 127. Thus, regions of the display-mode switching device 104 overlapping the third electrode stripes 124a can be transparent, and a plurality of second slits SL2 respectively corresponding to the third electrode stripes 124a can be displayed. By doing that, the ninth part P9 of the second sub-frame SF2 displayed by the display panel 102 can pass through the second slits SL2 and display in the third viewing angle regions VR3; the sixth part P6 of the second sub-frame SF2 can pass through the second slits SL2 and display in the second viewing angle regions VR2; the third part P3 can pass through the second slits SL2 and display in the first viewing angle regions VR1; and the sixteenth part P16 can pass through the second slits SL2 and display in the fourth viewing angle regions VR4. In this embodiment, the reference voltage Vcom is the same as the second voltage V2, the third voltage V3 and the fourth voltage V4, but the present invention is not limited thereto. Furthermore, the first electrode pattern 118, the second electrode pattern 120 and the fourth electrode pattern 126 can be electrically connected to one another in the second sub-frame time T2, so that the second voltage V2, the third voltage V3 and the fourth voltage V4 can be the same.

In step S18, the display panel 102 displays the third sub-frame SF3 in the third sub-frame time T3. In the third sub-frame time T3, the second voltage signal S2 and the common voltage signal Sc have the common voltage Vcom; the reference voltage signal Sr still has the reference voltage Vr; the first voltage signal S1 still has the fourth voltage V4; the third voltage signal S3 has the first voltage V1; and the fourth voltage signal S4 still has the third voltage V3. By doing that, regions of the display-mode switching device 104 without overlapping the second electrode stripes 120a will display black, and the third sub-frame SF3 displayed by the display panel 102 cannot pass through the regions of the display-mode switching device 104 without overlapping the second electrode stripes 120a. Also, the second electrode stripes 120a and the common electrode 127 have the same common electrode Vcom, so that there is no voltage difference between the second electrode stripes 120a and the common electrode 127. Thus, regions of the display-mode switching device 104 overlapping the second electrode stripes 120a can be transparent, and a plurality of third slits SL3 respectively corresponding to the second electrode stripes 120a can be displayed. Accordingly, the thirteenth part P13 of the third sub-frame SF3 displayed by the display panel 102 can pass through the third slits SL3 and display in the fourth viewing angle regions VR4; the tenth part P10 can pass through the third slits SL3 and display in the third viewing angle regions VR3; the seventh part P7 can pass through the third slits SL3 and display in the second viewing angle regions VR2; and the fourth part P4 can pass through the third slits SL3 and display in the first viewing angle regions VR1. In this embodiment, the reference voltage Vcom is the same as the first voltage V1, the third voltage V3 and the fourth voltage V4, but the present invention is not limited thereto. Furthermore, the first electrode pattern 118, the third electrode pattern 124 and the fourth electrode pattern 126 can be electrically connected to one another in the third sub-frame time T3, so that the first voltage V1, the third voltage V3 and the fourth voltage V4 can be the same.

In step S110, the display panel 102 displays the fourth sub-frame SF4 in the fourth sub-frame time T4. In the fourth sub-frame time T4, the fourth voltage signal S4 and the common voltage signal Sc have the common voltage Vcom; the reference voltage signal Sr still has the reference voltage Vr; the first voltage signal S1 still has the fourth voltage V4; the third voltage signal S3 still has the first voltage V1; and the second voltage signal S2 has the second voltage V2. By doing that, regions of the display-mode switching device 104 without overlapping the fourth electrode stripes 126a will display black, and the fourth sub-frame SF4 displayed by the display panel 102 cannot pass through the regions of the display-mode switching device 104 without overlapping the fourth electrode stripes 126a. Also, the fourth electrode stripes 126a and the common electrode 127 have the same common electrode Vcom, so that there is no voltage difference between the fourth electrode stripes 126a and the common electrode 127. Thus, regions of the display-mode switching device 104 overlapping the fourth electrode stripes 126a can be transparent, and a plurality of fourth slits SL4 respectively corresponding to the fourth electrode stripes 126a can be displayed. Accordingly, the first part P1 of the fourth sub-frame SF4 displayed by the display panel 102 can pass through the fourth slits SL4 and display in the first viewing angle regions VR1; the fourteenth part P14 can pass through the fourth slits SL4 and display in the fourth viewing angle regions VR4; the eleventh part P11 can pass through the fourth slits SL4 and display in the third viewing angle regions VR3; and the eighth part P8 can pass through the fourth slits SL4 and display in the second viewing angle regions VR2. In this embodiment, the reference voltage Vcom is the same as the first voltage V1, the second voltage V2 and the fourth voltage V4, but the present invention is not limited thereto. Furthermore, the first electrode pattern 118, the second electrode pattern 120 and the third electrode pattern 124 can be electrically connected to one another in the fourth sub-frame time T4, so that the first voltage V1, the second voltage V2 and the fourth voltage V4 can be the same.

During the first sub-frame time T1, the second sub-frame time T2, the third sub-frame time T3 and the fourth sub-frame time T4, the second part P2, the third part P3, the fourth part P4 and the first part P1 are sequentially displayed in the first viewing angle regions VR1, so that the observer can see the whole first viewing angle frame VF1 in the first viewing angle regions VR1. The fifth part P5, the sixth part P6, the seventh part P7 and the eighth part P8 are sequentially displayed in the second viewing angle regions VR2, so that the observer can see the whole second viewing angle frame VF2 in the second viewing angle regions VR2. The twelfth part P12, ninth part P9, the tenth part P10 and the eleventh part P11 are sequentially displayed in the third viewing angle regions VR3, so that the observer can see the whole third viewing angle frame VF3 in the third viewing angle regions VR3. The fifteenth part P15, sixteenth part P16, the thirteenth part P13 and the fourteenth part P14 are sequentially displayed in the fourth viewing angle regions VR4, so that the observer can see the whole fourth viewing angle frame VF4 in the fourth viewing angle regions VR4. When the left eye E1 and the right eye E2 of the observer are located at the third viewing angle region VR3 and the second viewing angle region V2 respectively, the observer can see the stereoscopic image formed by the third viewing angle frame VF3 and the second viewing angle frame VF2. Or, the left eye E1 and the right eye E2 also may be located at the second viewing angle region VR2 and the first viewing angle region VR1 respectively, so that the observer can see the stereoscopic image formed by the second viewing angle frame VF2 and the first viewing angle frame VF1. Or, the left eye E1 and the right eye E2 also may be located at the fourth viewing angle region VR4 and the third viewing angle region VR3 respectively, so that the observer can see the stereoscopic image formed by the fourth viewing angle frame VF4 and the third viewing angle frame VF3. Therefore, the display method of the stereoscopic display device in this embodiment can display four different viewing angle frames in four different viewing angle regions, so that the observer can see different stereoscopic images through changing position of the observer.

Additionally, the reference voltage Vr, the first voltage V1, the second voltage V2, the third voltage V3 and the fourth voltage V4 are larger than the common voltage Vcom in a frame period Ta of one of two of the stereoscopic images displayed continuously, and the reference voltage —Vr, the first voltage —V1, the second voltage —V2, the third voltage —V3 and the fourth voltage —V4 are less than the common voltage Vcom in a frame period Tb of the other one of the two of the stereoscopic images displayed continuously. In other words, in the frame period Ta, the reference voltage Vr is larger than the common voltage Vcom, so that the display-mode switching device 104 has a positive polarity. In the frame period Tb, the reference voltage —Vr is less than the common voltage Vcom, so that the display-mode switching device 104 has a negative polarity. Accordingly, the liquid crystal layer 112 of the display-mode switching device 104 can be driven with a polarity inversion method, so that the liquid crystal molecules can be prevented from being incapable of rotating. In a modified embodiment of the present invention, the sequence of the frame periods Ta, Tb may be exchanged. Furthermore, the reference voltage, the first voltage, the second voltage, the third voltage and the fourth voltage may be different from one another. Or, at least two of them are different from one another.

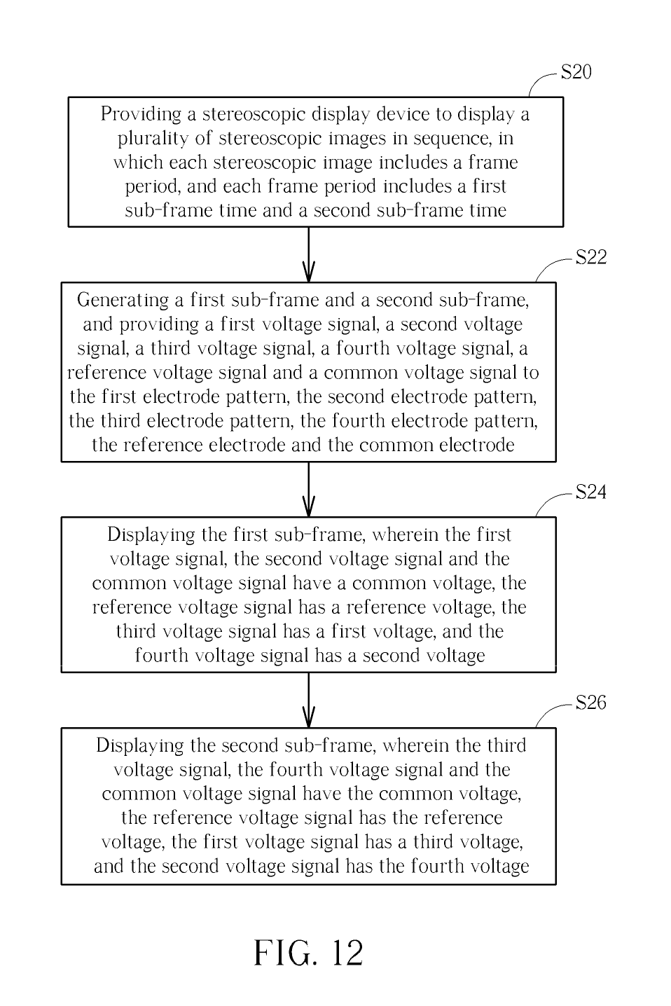

The stereoscopic display device of the present invention may display the stereoscopic image with two viewing angles. The display method of the stereoscopic display device for displaying the stereoscopic image with two viewing angles will be further detailed in the following description. Please refer to FIG. 12 together with FIG. 1. FIG. 12 is a flow chart of a display method of the stereoscopic display device according to another embodiment of the present invention. As shown in FIG. 1 and FIG. 12, the stereoscopic display device 100 operates in another display mode for displaying two viewing angle frames in this embodiment. The display method includes the following steps:

Step S20: providing a stereoscopic display device 100 to display a plurality of stereoscopic images in sequence, in which each stereoscopic image includes a frame period, and each frame period includes a first sub-frame time and a second sub-frame time;

Step S22: generating a first sub-frame and a second sub-frame through the display panel based on each of the stereoscopic images, and providing a first voltage signal, a second voltage signal, a third voltage signal, a fourth voltage signal, a reference voltage signal and a common voltage signal to the first electrode pattern, the second electrode pattern, the third electrode pattern, the fourth electrode pattern, the reference electrode and the common electrode;

Step S24: displaying the first sub-frame in each first sub-frame time, wherein the first voltage signal, the second voltage signal and the common voltage signal have a common voltage, the reference voltage signal has a reference voltage, the third voltage signal has a first voltage, and the fourth voltage signal has a second voltage in each first sub-frame time; and

Step S26: displaying the second sub-frame in each second sub-frame time, wherein the third voltage signal, the fourth voltage signal and the common voltage signal have the common voltage, the reference voltage signal has the reference voltage, the first voltage signal has a third voltage, and the second voltage signal has the fourth voltage in each second sub-frame time.

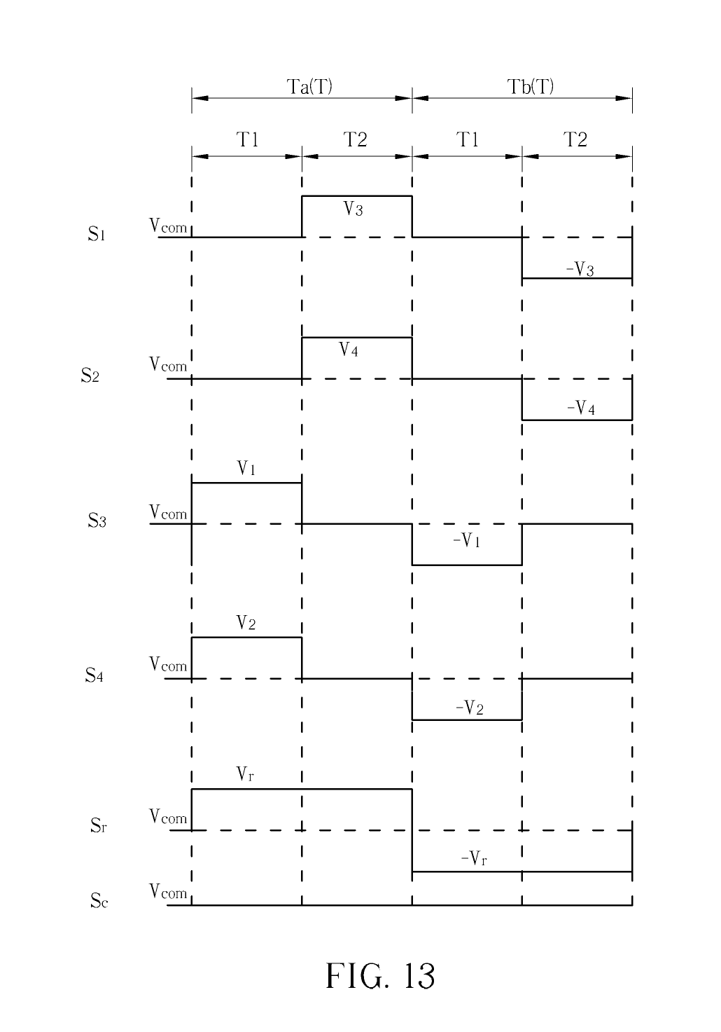

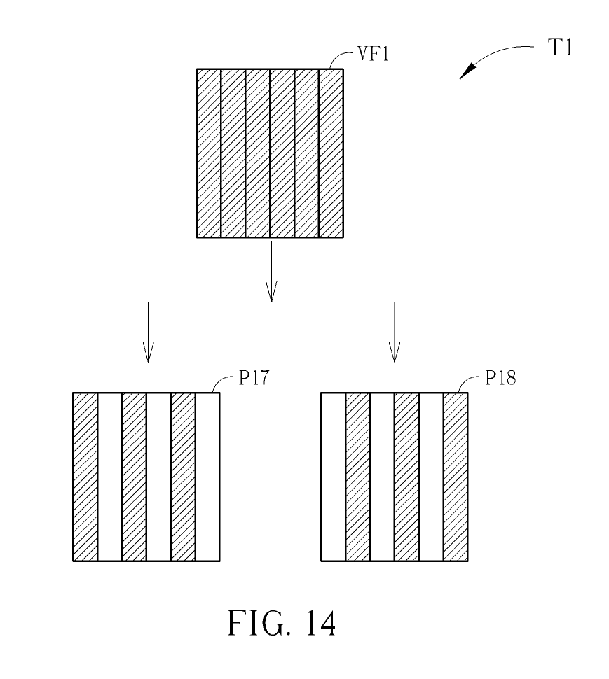

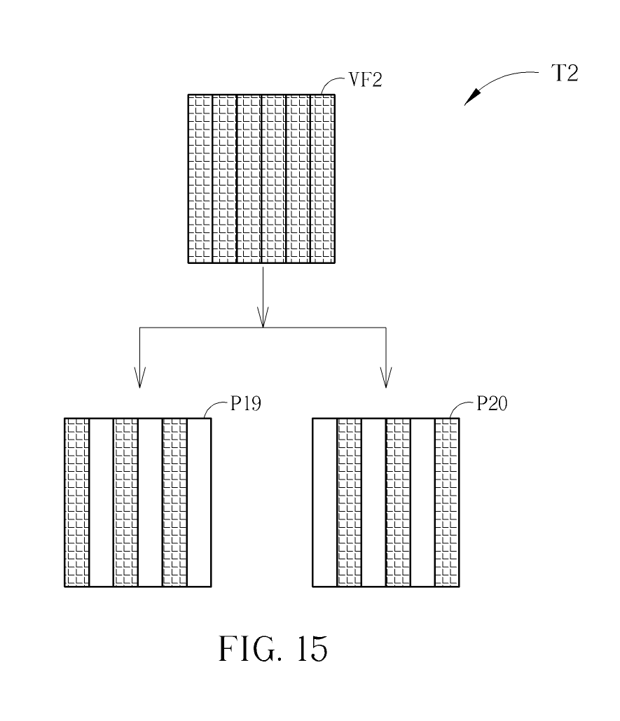

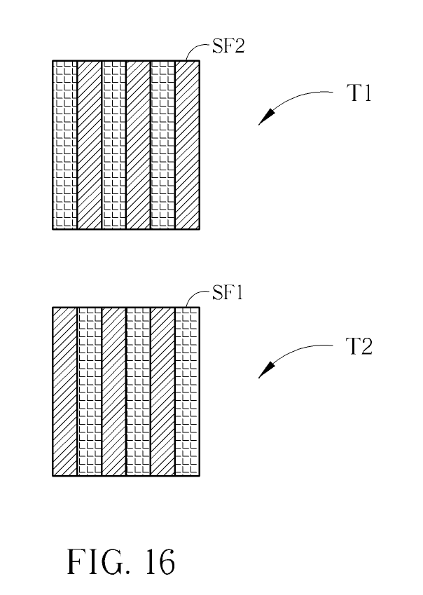

Please refer to FIG. 13 through FIG. 16 together with FIG. 1 and FIG. 12. FIG. 13 is a schematic diagram illustrating timing sequences of the first voltage signal, the second voltage signal, the third voltage signal, the fourth voltage signal, the reference voltage signal, and the common voltage signal when the stereoscopic display device displays the stereoscopic images according to this embodiment of the present invention. FIG. 14 through FIG. 15 are schematic diagrams illustrating two viewing angle frames divided by the display panel respectively according to this embodiment of the present invention. FIG. 16 is a schematic diagram illustrating the first sub-frame and the second sub-frame according to this embodiment of the present invention. As shown in FIG. 1, FIG. 12 and FIG. 13, the display method of this embodiment takes the stereoscopic display device 100 of the first embodiment as an example, but the present invention is not limited thereto. The frame period T of each stereoscopic image includes a first sub-frame time T1 and a second sub-frame time T2 in sequence. For clarity, the following description takes single one stereoscopic image as an example to detail the display method of the stereoscopic display device 100 for displaying each stereoscopic image. The present invention is not limited herein. The stereoscopic image is formed with two viewing angle frames, and the two viewing angle frames can be divided into a first viewing angle frame VF1 and a second viewing angle frame VF2 in this embodiment. The first viewing angle frame VF1 is displayed in a plurality of first viewing angle regions, and the second viewing angle frame VF2 is displayed in a plurality of second viewing angle regions. Each first viewing angle region and each second viewing angle region are sequentially arranged along the first direction. Also, there is a specific distance between the stereoscopic display device 100 and the first and second viewing angle regions VR1, VR2. Thus, a left eye and a right eye of an observer can be respectively located at each first viewing angle region and each second viewing angle region adjacent to each other and see the stereoscopic image.

In step S22, the display panel 102 generates a first sub-frame SF1, a second sub-frame SF2, a third sub-frame SF3 and a fourth sub-frame SF4 based on the stereoscopic image and displays the first sub-frame SF1 and the second sub-frame SF2 in sequence. Also, the first sub-frame SF1 and the second sub-frame SF2 can be displayed in different viewing angle regions through the switch of the display-mode switching device 104 so as to display different viewing angle frames. The method of the display panel 102 for generating the first sub-frame SF1 and the second sub-frame SF2 is detailed in the following description, but is not limited herein. In this embodiment, the display panel 102 first divides the first viewing angle frame VF1 into a seventeenth part P17 and an eighteenth part P18, as shown in FIG. 14. At the same time, as shown in FIG. 15, the display panel 102 divides the second viewing angle frame VF2 into a nineteenth part P19 and a twentieth part P20. Then, as shown in FIG. 16, the display panel 102 merges the seventeenth part P17 and the twentieth part P20 into the first sub-frame SF1 and merges the eighteenth part P18 and the nineteenth part P19 into the second sub-frame SF2. The first sub-frame and the second sub-frame in the present invention are not limited to the above-mentioned description, and may be exchanged. The first sub-frame and the second sub-frame may be adjusted and matched based on the positions of the slits displayed by the display-mode switching device. In the display-mode switching device 104, the first voltage signal S1 may be transmitted to the first electrode stripe 118a through the first signal end 128 and the first conductive line 118b. The second voltage signal S2 may be transmitted to the second electrode stripe 120a through the second signal end 130 and the second conductive line 120b. The third voltage signal S3 may be transmitted to the third electrode stripe 124a through the third signal end 132 and the third conductive line 124b. The fourth voltage signal S4 may be transmitted to the fourth electrode stripe 126a through the fourth signal end 134 and the fourth conductive line 126b. Furthermore, the first voltage signal S1, the second voltage signal S2, the third voltage signal S3, the fourth voltage signal S4, the reference voltage signal Sr and the common voltage signal Sc may be provided with a control device, but the present invention is not limited thereto.

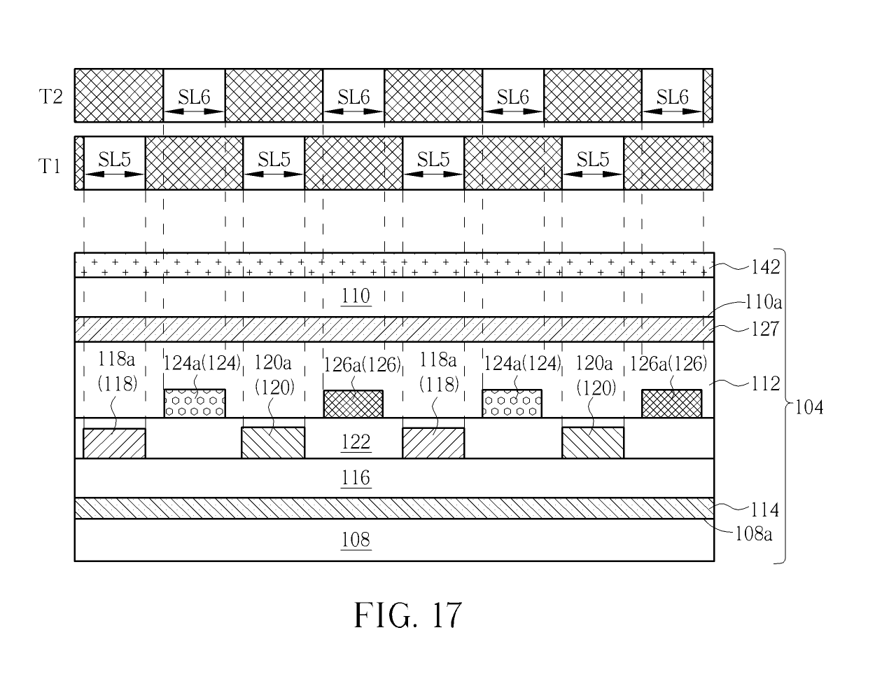

Please refer to FIG. 17 together with FIG. 1, FIG. 12, FIG. 13 and FIG. 16. FIG. 17 is a schematic diagram illustrating the slits displayed by the display-mode switching device corresponding to two viewing angle frames according to this embodiment of the present invention. As shown in FIG. 1, FIG. 12, FIG. 13, FIG. 16 and FIG. 17, in step S24, the display panel 102 displays the first sub-frame SF1 in the first sub-frame time T1. In the first sub-frame time T1, the first voltage signal S1, the second voltage signal S2 and the common voltage signal Sc have the common voltage Vcom, such as 0 volts, but are not limited thereto. The reference voltage signal Sr has the reference voltage Vr larger than the common voltage Vcom in the first sub-frame time T1. For example, a voltage difference between reference voltage Vr and the common voltage may be ranged from 2 volts to 6 volts, but is not limited thereto. The third voltage signal S3 has the first voltage V1 larger than the common voltage Vcom in the first sub-frame time T1. For example, a voltage difference between the first voltage V1 and the common voltage Vcom may be ranged from 2 volts to 6 volts, but is not limited thereto. The fourth voltage signal S4 has the second voltage V2 larger than the common voltage Vcom in the first sub-frame time T1. For example, a voltage difference between the second voltage V2 and the common voltage Vcom may be ranged from 2 volts to 6 volts, but is not limited thereto. It should be noted that the voltage difference between the reference voltage Vr and the common voltage Vcom is ranged from 2 volts to 6 volts; the voltage difference between the first voltage V1 and the common voltage Vcom is ranged from 2 volts to 6 volts; and the voltage difference between the second voltage V2 and the common voltage Vcom is ranged from 2 volts to 6 volts in this embodiment. By doing that, regions of the display-mode switching device 104 without overlapping the first electrode stripes 118a and the second electrode stripes 120a will display black, and the first sub-frame SF1 displayed by the display panel 102 cannot pass through the regions of the display-mode switching device 104 without overlapping the first electrode stripes 118a and the second electrode stripes 120a. Also, the first electrode stripes 118a, the second electrode stripes 120a and the common electrode 127 have the same common electrode Vcom, so that there is no voltage difference between the first electrode stripes 118a and the common electrode 127 and between the second electrode stripes 120a and the common electrode 127. Accordingly, regions of the display-mode switching device 104 overlapping the first electrode stripes 118a and the second electrode stripes 120a can be transparent, and a plurality of fifth slits SL1 respectively corresponding to the first electrode stripes 118a and the second electrode stripes 120a can be displayed. Thus, the seventeenth part P17 of the first sub-frame SF1 displayed by the display panel 102 can pass through the fifth slits SL5 and display in the first viewing angle regions, and the twentieth part P20 of the first sub-frame SF1 can pass through the fifth slits SL5 and display in the second viewing angle regions. In this embodiment, the reference voltage Vcom is the same as the first voltage V1 and the second voltage V2, but the present invention is not limited thereto. Furthermore, the first electrode pattern 118 and the second electrode pattern 120 can be electrically connected to the common electrode 127 in the first sub-frame time T1, and have the common voltage Vcom. The third electrode pattern 124 and the fourth electrode pattern 126 can be electrically connected to the reference electrode 114, so that the first voltage V1 and the second voltage V2 can be the same as the reference voltage Vr. In a modified embodiment of the present invention, the first electrode pattern, the third electrode pattern and the common electrode may be electrically insulated from one another, and may be provided with the same common voltage so as to have the same electrical potential. Furthermore, the second electrode pattern, the fourth electrode pattern and the reference electrode also may be electrically insulated from one another, and may be provided with voltages, in which the voltage differences between the voltages and the common voltage are larger than 2 volts. Thus, the second electrode pattern, the fourth electrode pattern and the reference electrode can control the corresponding liquid crystal molecules respectively.

In step S26, the display panel 102 displays the second sub-frame SF2 in the second sub-frame time T2. In the second sub-frame time T2, the third voltage signal S3, the fourth voltage signal S4 and the common voltage signal Sc have the common voltage Vcom; the reference voltage signal Sr still has the reference voltage Vr; the first voltage signal S1 has the third voltage V3 larger than the common voltage Vcom, for example, a voltage difference between the third voltage V3 and the common voltage Vcom being ranged from 2 volts to 6 volts, but is not limited thereto; and the second voltage signal S2 has the fourth voltage V4, for example, a voltage difference between the fourth voltage V4 and the common voltage Vcom being ranged from 2 volts to 6 volts. It should be noted that the voltage difference between the third voltage V3 and the common voltage Vcom is ranged from 2 volts to 6 volts, and the voltage difference between the fourth voltage V4 and the common voltage Vcom is ranged from 2 volts to 6 volts in this embodiment. Accordingly, regions of the display-mode switching device 104 without overlapping the third electrode stripes 124a and the fourth electrode stripes 126a will display black, and the second sub-frame SF2 displayed by the display panel 102 cannot pass through the regions of the display-mode switching device 104 without overlapping the third electrode stripes 124a and the fourth electrode stripes 126a. Also, the third electrode stripes 124a, the fourth electrode stripes 126a and the common electrode 127 have the same common electrode Vcom, so that there is no voltage difference between the third electrode stripes 124a and the common electrode 127 and between the fourth electrode stripes 126a and the common electrode 127. Thus, regions of the display-mode switching device 104 overlapping the third electrode stripes 124a and the fourth electrode stripes 126a can be transparent, and a plurality of sixth slits SL2 respectively corresponding to the third electrode stripes 124a and the fourth electrode stripes 126a can be displayed. By doing that, the eighteenth part P18 of the second sub-frame SF2 displayed by the display panel 102 can pass through the sixth slits SL6 and display in the first viewing angle regions; the nineteenth part P19 of the second sub-frame SF2 can pass through the sixth slits SL6 and display in the second viewing angle regions. In this embodiment, the reference voltage Vcom is the same as the third voltage V3 and the fourth voltage V4, but the present invention is not limited thereto. Furthermore, the third electrode pattern 124, the fourth electrode pattern 126 and the common electrode 127 can be electrically connected to one another in the second sub-frame time T2 so as to have the same common voltage Vcom. The first electrode pattern 118, the second electrode pattern 120 and the reference electrode 114 can be electrically connected to one another in the second sub-frame time T2, so that the third voltage V3, the fourth voltage V4 and the reference voltage Vr can be the same. In a modified embodiment of the present invention, the first electrode pattern, the third electrode pattern and the reference electrode may be electrically insulated from one another, and may be provided with voltages, in which the voltage differences between the voltages and the common voltage are larger than 2 volts. Thus, the first electrode pattern, the third electrode pattern and the reference electrode can control the corresponding liquid crystal molecules respectively. Furthermore, the second electrode pattern, the fourth electrode pattern and the common electrode also may be electrically insulated from one another, and may be provided with the same common voltage so as to have the same electrical potential.

During the first sub-frame time T1 and the second sub-frame time T2, the seventeenth part P17 and the eighteenth part P18 are sequentially displayed in the first viewing angle regions, so that the observer can see the whole first viewing angle frame VF1 in the first viewing angle regions. The twentieth part P20 and the nineteenth part P19 are sequentially displayed in the second viewing angle regions, so that the observer can see the whole second viewing angle frame VF2 in the second viewing angle regions VR2. When the left eye and the right eye of the observer are located at the first viewing angle region and the second viewing angle region adjacent to each other respectively, the observer can see the stereoscopic image formed by the first viewing angle frame VF1 and the second viewing angle frame VF2. Thus, the stereoscopic display device not only can display the stereoscopic image with four viewing angle frames, but also can display the stereoscopic image with two viewing angle frames.

Additionally, the reference voltage Vr, the first voltage V1, the second voltage V2, the third voltage V3 and the fourth voltage V4 are larger than the common voltage Vcom in a frame period Ta of one of two sequentially displayed stereoscopic images, and the reference voltage —Vr, the first voltage —V1, the second voltage —V2, the third voltage —V3 and the fourth voltage —V4 are less than the common voltage Vcom in a frame period Tb of the other one of the two sequentially displayed stereoscopic images. In other words, in the frame period Ta, the reference voltage Vr is larger than the common voltage Vcom, so that the display-mode switching device 104 has a positive polarity. In the frame period Tb, the reference voltage —Vr is less than the common voltage Vcom, so that the display-mode switching device 104 has a negative polarity. Accordingly, the liquid crystal layer 112 of the display-mode switching device 104 can be driven with a polarity inversion method, so that the liquid crystal molecules can be prevented from being incapable of rotating. In a modified embodiment of the present invention, the sequence of the frame periods Ta, Tb may be exchanged. Furthermore, the reference voltage, the first voltage, the second voltage, the third voltage and the fourth voltage may be different from one another. Or, at least two of them are different from one another.

In summary, the stereoscopic display device not only can display the stereoscopic image with four viewing angle frames, but also can display the stereoscopic image with two viewing angle frames through different display methods in the present invention. Accordingly, the number of the display modes of the stereoscopic display device can be increased, and the number of the viewing angle frames also can be increased in different modes. Thus, the observer can have more choices to choose the required display mode.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A display-mode switching device, comprising:
a first substrate having a first surface;
a first electrode pattern disposed on the first substrate, and the first electrode pattern comprising a plurality of first electrode stripes parallel to each other;
a second electrode pattern disposed on the first substrate, and the second electrode pattern comprising a plurality of second electrode stripes parallel to each other;
a third electrode pattern disposed on the first substrate, and the third electrode pattern comprising a plurality of third electrode stripes parallel to each other;
a fourth electrode pattern disposed on the first substrate, and the fourth electrode pattern comprising a plurality of fourth electrode stripes parallel to each other, wherein each first electrode stripe, each third electrode stripe, each second electrode stripe and each fourth electrode stripe are sequentially arranged along a direction; and
a common electrode covering the first surface of the first substrate.

2. The display-mode switching device according to claim 1, further comprising a second substrate having a second surface disposed opposite to the first surface of the first substrate.

3. The display-mode switching device according to claim 2, further comprising a liquid crystal layer disposed between the first substrate and the second substrate.

4. The display-mode switching device according to claim 1, further comprising a reference electrode covering the first surface of the first substrate.

5. The display-mode switching device according to claim 4, further comprising a first insulating layer covering the reference electrode.

6. The display-mode switching device according to claim 1, further comprising a second insulating layer disposed between the first electrode pattern and the third electrode pattern and between the second electrode pattern and the fourth electrode pattern.

7. The display-mode switching device according to claim 1, further comprising a second insulating layer disposed between the second electrode pattern and the third electrode pattern.

8. The display-mode switching device according to claim 7, further comprising a third insulating layer disposed between the first electrode pattern and the second electrode pattern.

9. The display-mode switching device according to claim 7, further comprising a fourth insulating layer disposed between the third electrode pattern and the fourth electrode pattern.

10. A stereoscopic display device, comprising:
a display panel having a display surface; and
a display-mode switching device according to claim 1, disposed on the display surface.

11. A display method of a stereoscopic display device, comprising:
providing the stereoscopic display device according to claim 10 to display a plurality of stereoscopic images in sequence, wherein each stereoscopic image comprises a frame period, and each frame period comprises a first sub-frame period, a second sub-frame time, a third sub-frame time, and a fourth sub-frame time; and
generating a first sub-frame, a second sub-frame, a third sub-frame, and a fourth sub-frame through the display panel based on each stereoscopic image, and providing a first voltage signal, a second voltage signal, a third voltage signal, a fourth voltage signal, a reference voltage signal and a common voltage signal to the first electrode pattern, the second electrode pattern, the third electrode pattern, the fourth electrode pattern, the reference electrode and the common electrode respectively.

12. The display method of the stereoscopic display device according to claim 11, further comprising:
displaying the first sub-frame in each first sub-frame time, wherein the first voltage signal and the common voltage signal have a common voltage, the reference voltage signal has a reference voltage, the third voltage signal has a first voltage, the second voltage signal has a second voltage, and the fourth voltage signal has a third voltage in each first sub-frame time;
displaying the second sub-frame in each second sub-frame time, wherein the third voltage signal and the common voltage signal have the common voltage, the reference voltage signal has the reference voltage, the first voltage signal has a fourth voltage, the second voltage signal has the second voltage, and the fourth voltage signal has the third voltage in each second sub-frame time;
displaying the third sub-frame in each third sub-frame time, wherein the second voltage signal and the common voltage signal have the common voltage, the reference voltage signal has the reference voltage, the first voltage signal has the fourth voltage, the third voltage signal has the first voltage, and the fourth voltage signal has the third voltage in each third sub-frame time; and
displaying the fourth sub-frame in each fourth sub-frame time, wherein the fourth voltage signal and the common voltage signal have the common voltage, the reference voltage signal has the reference voltage, the first voltage signal has the fourth voltage, the third voltage signal has the first voltage, and the second voltage signal has the second voltage in each fourth sub-frame time.

13. The display method of the stereoscopic display device according to claim 12, wherein the reference voltage, the first voltage, the second voltage, the third voltage, and the fourth voltage are larger than the common voltage in the frame period of one of two of the stereoscopic images displayed continuously.

14. The display method of the stereoscopic display device according to claim 12, wherein the reference voltage, the first voltage, the second voltage, the third voltage, and the fourth voltage are less than the common voltage in the frame period of the other one of the two of the stereoscopic images displayed continuously.

15. The display method of the stereoscopic display device according to claim 12, wherein the reference voltage is the same as the first voltage, the second voltage, the third voltage, and the fourth voltage.

16. A display method of a stereoscopic display device, comprising:
providing the stereoscopic display device according to claim 10 to display a plurality of stereoscopic images in sequence, wherein each stereoscopic image comprises a frame period, and each frame period comprises a first sub-frame time and a second sub-frame time; and
generating a first sub-frame and a second sub-frame through the display panel based on each stereoscopic image, and providing a first voltage signal, a second voltage signal, a third voltage signal, a fourth voltage signal, a reference voltage signal and a common voltage signal to the first electrode pattern, the second electrode pattern, the third electrode pattern, the fourth electrode pattern, the reference electrode and the common electrode respectively.

17. The display method of the stereoscopic display device according to claim 16, further comprising:
displaying the first sub-frame in each first sub-frame time, wherein the first voltage signal, the second voltage signal and the common voltage signal have a common voltage, the reference voltage signal has a reference voltage, the third voltage signal has a first voltage, and the fourth voltage signal has a second voltage in each first sub-frame time; and
displaying the second sub-frame in each second sub-frame time, wherein the third voltage signal, the fourth voltage signal and the common voltage signal have the common voltage, the reference voltage signal has the reference voltage, the first voltage signal has a third voltage, and the second voltage signal has the fourth voltage in each second sub-frame time.

18. The display method of the stereoscopic display device according to claim 17, wherein the reference voltage, the first voltage, the second voltage, the third voltage, and the fourth voltage are larger than the common voltage in the frame period of one of two of the stereoscopic images displayed continuously.

19. The display method of the stereoscopic display device according to claim 17, wherein the reference voltage, the first voltage, the second voltage, the third voltage, and the fourth voltage are less than the common voltage in the frame period of the other one of the two of the stereoscopic images displayed continuously.

20. The display method of the stereoscopic display device according to claim 17, wherein the reference voltage is the same as the first voltage, the second voltage, the third voltage, and the fourth voltage.
